(19) United States
(12) Patent Application Publication
(10) Pub. No.: US 2025/0094805 A1
(43) Pub. Date: Mar. 20, 2025

(54) POLYMORPHIC PRUNING OF NEURAL NETWORKS

(71) Applicant: Entanglement, Inc., Miami, FL (US)

(72) Inventors: Anna HUGHES, Miami, FL (US); Amit VERMA, Miami, FL (US); Haibo WANG, Laredo, TX (US); Gary KOCHENBERGER, Denver, CO (US); Fred GLOVER, Boulder, CO (US); Amit HULANDAGERI, Miami, FL (US)

(73) Assignee: Entanglement, Inc., Miami, FL (US)

(21) Appl. No.: 18/889,814

(22) Filed: Sep. 19, 2024

Related U.S. Application Data
(60) Provisional application No. 63/539,542, filed on Sep. 20, 2023.

(51) Int. Cl. G06N 3/082

(52) U.S. Cl. CPC G06N 3/082

(57) ABSTRACT

A method and system for polymorphic pruning of neural networks are disclosed. The method involves training a neural network model on an input dataset for an initial predetermined number of iterations to gather weight information, including the strength of each weight and changes in strength over iterations. The weights are stored in an array accessible to a pruning algorithm. An objective function is compiled using the weight information, and an optimization tool solves the objective function to generate a solution vector. This solution vector is used to create a pruning mask, which is applied to the neural network model to prune certain weights by setting them to zero. The pruned weight vector updates the model, resulting in a neural network with fewer non-zero connections between neurons.

### CROSS-REFERENCE TO RELATED APPLICATION

This application claims priority benefit to U.S. Provisional Patent Application No. 63/539,542, filed Sep. 20, 2023, entitled “Polymorphic Pruning of Neural Networks”, which is hereby incorporated herein by reference in its entirety.

### TECHNICAL FIELD

The present disclosure relates generally to the field of machine learning and neural networks. More specifically, it pertains to methods and systems for pruning neural networks using polymorphic pruning techniques to optimize computational efficiency during training and inference.

### BACKGROUND

Neural networks have become integral to modern machine learning, driving advancements in areas such as image recognition, natural language processing, and autonomous systems. As the complexity and size of neural networks increase to achieve higher accuracy, they demand substantial computational resources for both training and inference phases. This escalation in computational requirements poses challenges related to processing speed, energy consumption, and the feasibility of deploying such networks on resource-constrained devices.

Pruning is a widely adopted technique aimed at reducing the size and computational demands of neural networks by removing weights or connections that contribute least to the network's performance. Traditional pruning methods often rely on static criteria, such as eliminating weights with the smallest absolute values or magnitudes. While these methods can effectively reduce network size, they may not optimally balance the trade-off between network sparsity and performance retention.

Moreover, existing pruning techniques frequently overlook the dynamic behavior of weights during the training process, such as changes in weight strength over iterations. This can lead to suboptimal pruning decisions, where weights that might become significant in later training stages are prematurely removed. Additionally, conventional methods may not leverage advanced optimization tools to determine the optimal set of weights to prune, potentially missing opportunities for enhanced efficiency.

There is a need for improved pruning methods that consider both the current strength of weights and their evolution during training. By collecting detailed information about weight strengths and their changes over initial training iterations, and formulating an objective function that can be optimized using advanced solvers, more informed and effective pruning decisions can be made. Such methods would enhance computational efficiency and reduce resource consumption without significantly compromising the performance of the neural network.

### SUMMARY

Polymorphic pruning of neural networks is described herein, among other computational features. This novel type of pruning can be implemented globally or layer-wise and may be implemented on weights of the neural network or other features described herein. In some examples, global polymorphic pruning removes weights across all layers, while local polymorphic pruning prunes the weights in each layer separately. Systems and methods described herein may perform layer-wise pruning, but can be applied to global pruning as well. When the polymorphic pruning is implemented in PyTorch, the process can be implemented either globally or layer-wise using the “torch.prune” functionality, which gives the option to perform either. Implementation in PyTorch is provided as an illustrative example and should not be limiting to the embodiments described herein.

In some examples, the model (M) is trained on an input dataset (X) for some initial set number N of iterations, which are used to gather information about the weights throughout a training process. The number of iterations N may be set by an administrator, and may vary between machine learning models and datasets. When the training of the model has reached a pre-determined number of iterations (N), it will automatically stop training while polymorphic pruning is performed or the pruning mask is determined.

The information gathered about the weights may include the strength of each weight (W) as well as the change in strength between iterations (ΔW). Weights that are consistently weak or weak in excess of a threshold value (e.g., low absolute value of W) may contribute least to the model. The system may determine and store a change in strength of the weight. This may help keep track of weights that are initialized at weak values and become stronger during training or vice versa.

The weights are stored in array H. Array H may be a local array designed to make weight information directly accessible to the pruning algorithm. The pruning algorithm, for example, may access the array and determine its values as an input argument to the pruning algorithm executed by the processor of the system.

Once the initial iterations of the training process are complete, the weight information H is used to compile an objective function, O. The objective function may be a function to be minimized or maximized in the specific optimization problem. Determining the minimum or maximum of the objective function can be performed using an optimization tool (e.g., Next Generation Quantum (NGQ) solver, Gurobi optimizer, or other optimization tool). In some examples, the system may maximize the strength of the weights and minimize possible correlations between weights.

A computer solver is called to find a solution vector V to O, which is used to create a pruning mask. In some examples, the computer solver will output a vector that is populated with binary values. The vector may be reshaped to create a 2D mask. A pruning mask may be applied, for example, using the PyTorch custom_mask pruning functionality. Some weights or other polymorphic features may be removed/pruned and some weights/polymorphic features may remain after the pruning mask is applied. For the weights that are kept, they may be multiplied by “1” in the mask and keep their original value, while pruned weights are set to “0.”

The system may generate a pruned weight vector from the pruning mask. For example, the PyTorch tool may apply the custom_mask to create a pruned weight tensor via element-wise matrix multiplication. The pruned weight tensor may correspond with the original tensor after this multiplication.

Finally, the pruned weight vector is used to update model M. In some examples, the system may automatically update the model upon implementing the pruning process. The model may be updated with PyTorch, although other applications may be implemented as well. A pruned neural network model (corresponding with the updated model) may have fewer non-zero connections between neurons. With fewer non-zero connections between neurons, fewer computations may be needed during both additional training phases and the inference phase after some weights have been removed. In this disclosure, “removing a weight” refers to marking the weight as zero.

### BRIEF DESCRIPTION OF DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates a polymorphic pruning system, in accordance with some of the embodiments disclosed herein.

FIG. 2 illustrates a neural network associated with the polymorphic pruning system, in accordance with some of the embodiments disclosed herein.

FIG. 3 illustrates a polymorphic pruning method executed by the polymorphic pruning system, in accordance with some of the embodiments disclosed herein.

FIG. 4 illustrates a polymorphic pruning method executed by the polymorphic pruning system, in accordance with some of the embodiments disclosed herein.

FIG. 5 illustrates a polymorphic pruning method, in accordance with some of the embodiments disclosed herein.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION

Neural networks (NNs) and deep neural networks (DNNs) may be used to develop complex generative models. Much of the success of NNs and DNNs can be attributed to the number of parameters used in the models, which in turn requires enormous computational resources and typically results in excessively long training times. To reduce the computational resources required and reduce the amount of training time needed, improvements to these systems advantageously reduce the size of a NN or DNN without sacrificing the accuracy of the output.

One such strategy is known as neural network weight pruning. Neural network weight pruning can improve existing systems by removing unneeded weights from the network. The goal is to remove insignificant parameters such that the network retains its quality, and also to remove enough parameters to significantly reduce the computations needed. Weights, used to determine the strength of each parameter throughout network layers, are a common target for pruning.

Identifying which and how many weights to prune is a non-trivial task. Both simplistic and complex measures are used to assess the saliency of weights, with the ultimate aim of removing weights that contribute least or not at all to the outcome. These measures are used to strategically remove weights, however, weights may also be pruned randomly. Simple strategic weight pruning methods broadly fall into two categories, including Magnitude Pruning (layer-wise or global) that removes the weights with the lowest absolute magnitude, and Gradient Pruning (layer-wise or global) that removes the weights with the lowest absolute value of (weight×gradient).

Weight pruning based on magnitude can include:

$${w}_{i} = \{ \begin{matrix}{w}_{i} & if \vert {w}_{i} \vert > λ \\ 0 & if \vert {w}_{i} \vert \leq λ ,\end{matrix} \qquad ( 1 )$$

where wᵢ corresponds to each weight and A is some threshold value.

Weight pruning based on sensitivity can include:

$${w}_{i} = \{ \begin{matrix}{w}_{i} & if \vert {w}_{i} \vert > s \cdot {σ}_{l} \\ 0 & if \vert {w}_{i} \vert \leq s \cdot {σ}_{l} ,\end{matrix} \qquad ( 2 )$$

where s is a set sensitivity value and o is the standard deviation of the weights in layer l. The determination of which weights to prune during training may be able to both increase the training speed as well as the accuracy of inference.

In some examples of the system, the pruning process is implemented as a combinatorial optimization problem, where the linear coefficients have individual weight properties, while the quadratic coefficients are values that represent the similarity between each weight pair. In some examples, the pair of weights may be treated as a vector of individual weight values that are collected during the initial N training iterations. The similarity between each pair of weights may be measured using various processes, including by using a cosine similarity.

Pruning may be implemented by considering the correlations between weights and other features of the system. In this framework, the goal of pruning may not be to eliminate weights that do not satisfy a set requirements, but to find the combination of weights to prune that may preserve or improve model accuracy.

Various pruning strategies may be implemented. Some strategies based on weight properties can be difficult to implement due to the limited information inherent with the weights themselves. However, by running a few training iterations of the model training and tracking weight values and gradients with each iteration, more advanced initial properties can be extracted (e.g., absolute value of the weight or gradient).

In some examples, the advanced initial properties can correspond to the importance of that particular weight. For example, the strength or importance of the weight may correspond with the absolute value of the weight itself. The absolute value of the weight may correspond with a parameter in the model. In some examples, the system may determine the square of the weight value (or other calculation of the weight value) to determine weight importance in a particular model. Other more advanced properties derived from the weight value or weight gradients may also produce measurements of the weight importance in a particular model. Some advanced secondary properties (e.g., standard deviation of values and gradients between iterations) may be less clear and require additional experimentation.

Considering potential correlations between different weights complicates the pruning problem. Pruning low-value weights is likely to reasonably preserve model accuracy and determining the correlations between the weights may enable additional pruning of those low-value weights with minimal further loss of accuracy. In some examples, the weights may be considered as features. The process may aim to remove weights that have little correlation with the target value (e.g., accuracy) as well as punishing weights that are strongly correlated with other weights.

The system may determine the weights or polymorphic features to prune from the neural network as an optimization problem, including a quadratic unconstrained binary optimization (QUBO), although QUBO is not necessary in all implementations. The optimization problem may combine one or more optimization problems that can include:

$$min / max y = {\vec{x}}^{t} Q \vec{x} = {\sum }_{i , j} {Q}_{i , j} {\vec{x}}_{i} {\vec{x}}_{j} \qquad ( 3 )$$

Where \vec{x} is a vector of binary decision variables and Q is a matrix of constants.

In some examples, the optimization problem may be a NP-hard problem. The optimization problem may lend itself to finding approximate optimal solutions. The optimization problem may contain both linear and quadratic terms, where the linear coefficients appear along the diagonal of matrix Q, while the quadratic coefficients appear as off-diagonal terms.

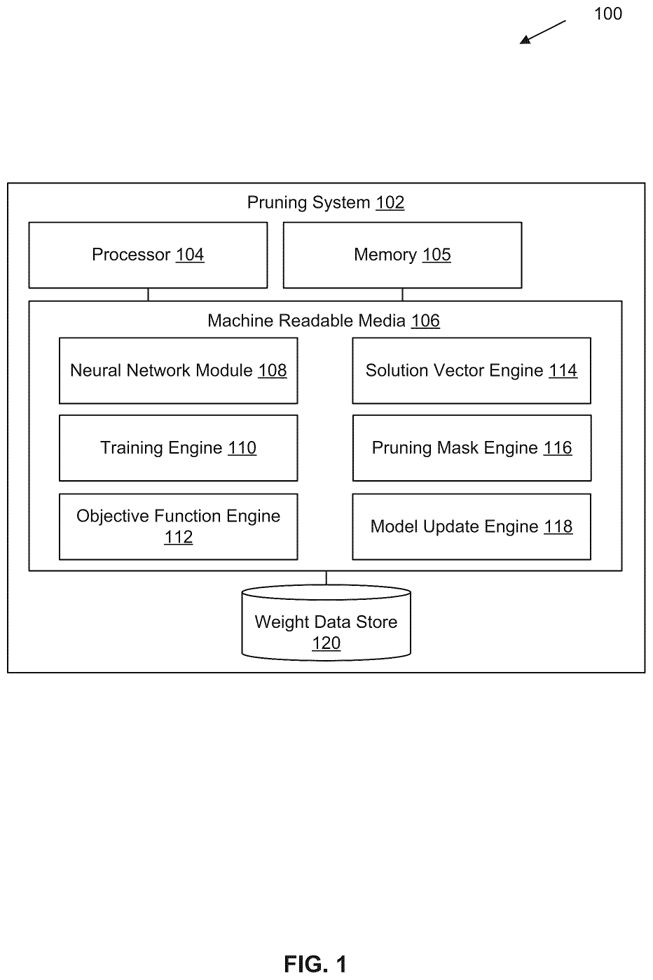

FIG. 1 illustrates a polymorphic pruning system, in accordance with some of the embodiments disclosed herein. In example 100, pruning system 102 is configured to determine weights to prune in a neural network or other model using processor 104 and store the weights in memory 105. Pruning system 102 may be implemented as a server computer with processor 104 being an efficient processor like a graphics processing unit (GPU), although such limitations are not required with each embodiment of the disclosure.

Processor 104 may comprise a general-purpose or special-purpose processing engine such as, for example, a microprocessor, controller, or other control logic. Processor 104 may be connected to a bus, although any communication medium can be used to facilitate interaction with other components of pruning system 102 or to communicate externally.

Memory 105 may comprise random-access memory (RAM) or other dynamic memory for storing information and instructions to be executed by processor 104. Memory 105 might also be used for storing temporary variables or other intermediate information during execution of instructions to be executed by processor 104. Memory 105 may also comprise a read only memory (“ROM”) or other static storage device coupled to a bus for storing static information and instructions for processor 104.

Machine readable media 106 may comprise one or more interfaces, circuits, engines, and modules for implementing the functionality discussed herein. Machine readable media 106 may carry one or more sequences of one or more instructions processor 104 for execution. Such instructions embodied on machine readable media 106 may enable pruning system 102 to perform features or functions of the disclosed technology as discussed herein. For example, the interfaces, circuits, and modules of machine readable media 106 may comprise, for example, neural network module 108, training engine 110, objective function engine 112, solution vector engine 114, pruning mask engine 116, and model update engine 118. Weight data store 120 may store weights between the nodes, as well as other information associated with the neural network.

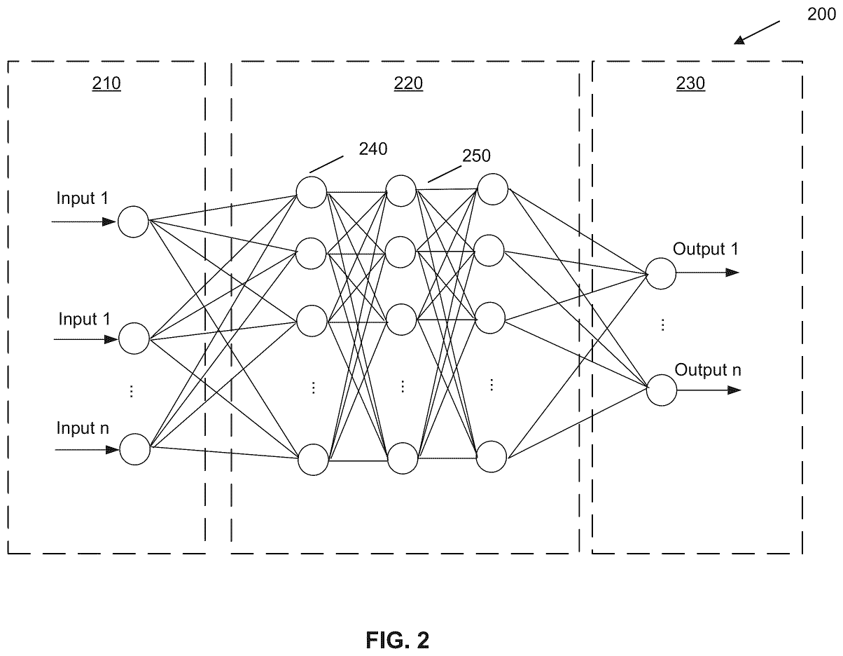

Neural network module 108 is configured to generate a neural network. An illustrative neural network is provided in FIG. 2.

Neural networks, including deep neural networks, comprise a set of processing nodes that are interconnected and weighted. To train the neural network, the weights of the nodes may be initially set to random values. As training data is fed to the first layer of the nodes, the data may pass through the next layers to transform the data to the output layer. During training, the weights and thresholds of each of the nodes may be adjusted until the neural network produces similar outputs for similar training data and labels.

As discussed herein, some examples of the computer may include, for example, NGQsolver, D-Wave solver, Gurobi solver, or other optimization tool, which is illustrated as “NGQ” in the algorithm provided herein.

Training engine 110 is configured to receive an input dataset. In some examples, training engine 110 is configured to train the model (M) on the input dataset (X).

Training engine 110 is configured to train the model for some set number (N) of iterations, which are used to gather information about the weights (W, A W, +params) throughout the training process. Training engine 110 is configured to store the weights in array (H), illustrated as weight data store 120.

Objective function engine 112 is configured to generate an objective function (O). The objective function may be generated once the initial iterations of the training process are complete. The weight information (H) is used to compile the objective function.

In some examples, weight pruning may be implemented with linear coefficients ₒᵢ; of each weight _{wi} and the quadratic coefficients bᵢⱼ of each weight pair wᵢwⱼ, The process can be expressed as an objective function to be maximized, including:

$$max {y}_{α} = α {\sum }_{i = N} {a}_{i} {\vec{x}}_{i} - ( 1 - α ) {\sum }_{i , j ∈ N i < j} {b}_{ij} {\vec{x}}_{i} {\vec{x}}_{j} , \qquad ( 4 )$$

where α is a tunable parameter. The objective function may be satisfied when the individual weight importance terms aᵢ are maximized while the inter-weight correlation terms bi; are minimized. The linear coefficients aᵢ are some combination of individual weight properties known or expected to correlate with weight importance. The quadratic coefficients, bᵢⱼ, represent some coupling term between each pair of weights.

In some examples, the linear terms are the sum of weight magnitude and absolute value of the weights×gradients and the quadratic terms are the cosine similarity between weight pairs, can be expressed as:

$$max {y}_{α} = α {\sum }_{i = N} \vert {w}_{i} + {δ}_{i} \cdot {w}_{i} \vert {\vec{x}}_{i} - ( 1 - α ) {\sum }_{i , j ∈ N i < j} \vert {c}_{ij} \vert {\vec{x}}_{i} {\vec{x}}_{j} \qquad ( 5 )$$

In some examples, the cosine similarity between two vectors such as \vec{ }w1 and\vec{ }w2 is represented as:

$$cosine similarity := cos ( θ ) = \frac{\vec{{w}_{1}} \cdot \vec{{w}_{2}}}{‖ \vec{{w}_{1}} ‖ ‖ \vec{{w}_{2}} ‖} = \frac{{\sum }_{i = 1}^{n} {w}_{i , 1} {w}_{i , 2}}{\sqrt{{\sum }_{i = 1}^{n} {w}_{i , 1}^{2} \cdot {w}_{i , 2}^{2}}} \qquad ( 6 )$$

In some examples, additional complex information about the weights can be included to make well-informed decisions about which weights to remove. The values for a can comprise, for example, a mean value of weight, a mean value of weight and gradient, a standard deviation of weights or gradients from a distribution mean, or a running average of differential change in a model loss function. The values for b can comprise, for example, a cosine similarity between weights, a cosine similarity between gradients, a Manhattan distance between weights, an Euclidean distance between weights, a Minkowski distance between weights, a Jaccard similarity between weights, a Manhattan distance between gradients, an Euclidean distance between gradients, a Minkowski distance between gradients, a Jaccard similarity between gradients, or a similarity between the differential model loss function.

In some examples, a and b values may be determined heuristically. When all terms are included, the process may create computational inefficiencies without increasing model accuracy.

In some examples, the neural network model itself may have a “cost function” or “loss function” (used interchangeably), while the “cost function” of the model may have an “objective function”. For example, during standard model training, a loss function is optimized using a gradient descent process or other optimization algorithm for finding a local minimum. It will do this whether or not weight pruning is implemented. Since weight pruning is framed as an optimization problem, it has an “objective function” that is optimized. In this context, the terms “loss function,” “objective function,” and “cost function” may be synonymous with each other. In some examples, the term “loss function” may be used in reference to the model and “objective function” may be used in reference to the weight pruning.

In some examples, the number or percentage of weights to prune may be fixed at a particular value. In some examples, the process may not allow for choosing how many weights to prune. Instead, the process may incorporate scalar penalties in both the linear and quadratic terms as:

$$max {y}_{α} = α {\sum }_{i = N} ( {a}_{i} - P ( 1 - {2}^{k} ) ) {\vec{x}}_{i} - ( 1 - α ) {\sum }_{i , j ∈ N i < j} ( {b}_{ij} - P ) {\vec{x}}_{i} {\vec{x}}_{j} \qquad ( 7 )$$

where P and k are tunable parameters that are set to the desired number of weights to prune.

In some examples, the computer to implement the process may be used to find approximate solutions that minimize or maximize the objective function. Some examples of the computer (e.g., computer solver or other computing device) may include, for example, Next Generation Quantum (NGQ) solver, D-Wave solver, Gurobi solver, or other optimization tool, and receive a Q matrix to initiate the process. In some examples, the computer may receive samples an input binary quadratic model (via the Q matrix), and outputs a vector of binary values. This output binary vector may be reshaped into a mask that can be applied to the weights through a pruning routine. Using the mask, the pruning routine will set the minimally impactful weights to zeros while retaining all other weights at their pre-pruned value.

Solution vector engine 114 is configured to generate a solution vector to the objective function (O). For example, the objective function may be a function to be minimized or maximized in the specific optimization problem. Determining the minimum or maximum of the objective function can be performed using an optimization tool (e.g., NGQ solver, Gurobi optimizer, or other optimization tool). In some examples, the system may broadly maximize the strength of the weights and minimize possible correlations between weights.

Pruning mask engine 116 is configured to generate a pruning mask from the solution vector (V). For example, the output of solution vector engine 114 may generate the solution vector, which can be reshaped into a 2D mask. The pruning mask may be applied to remove/prune some weights and some weights may remain after the pruning mask is applied. For the weights that are kept, they may be multiplied by “1” in the mask and keep their original value, while pruned weights are set to “0.”

Pruning mask engine 116 is also configured to generate a pruned weight vector from the pruning mask using the processes described herein. For example, pruning mask engine 116 may apply the mask to create a pruned weight tensor via element-wise matrix multiplication. The pruned weight tensor may correspond with the original tensor after multiplication.

Model update engine 118 is configured to update the model (M) using the pruned weight vector. In some examples, model update engine 118 is configured to automatically update the model upon implementing the weight pruning process executed by pruning mask engine 116. A pruned neural network model (corresponding with the updated model) may have fewer non-zero connections between neurons. With fewer non-zero connections between neurons, fewer computations may be needed during both additional training phases and the inference phase after some weights have been removed.

In some examples, model update engine 118 is configured to implement weight pruning globally or layer-wise. In some examples, an administrative user may select global or layer-wise weight pruning. Systems and methods described herein may perform layer-wise pruning, but can be applied to global pruning as well.

FIG. 2 illustrates a neural network associated with the polymorphic pruning system, in accordance with some of the embodiments disclosed herein. In example 200, the neural network may comprise input layer 210, hidden layers 220, and output layer 230. Each of these layers may comprise a set of nodes, including node 240, and weights between the nodes, including weight 250.

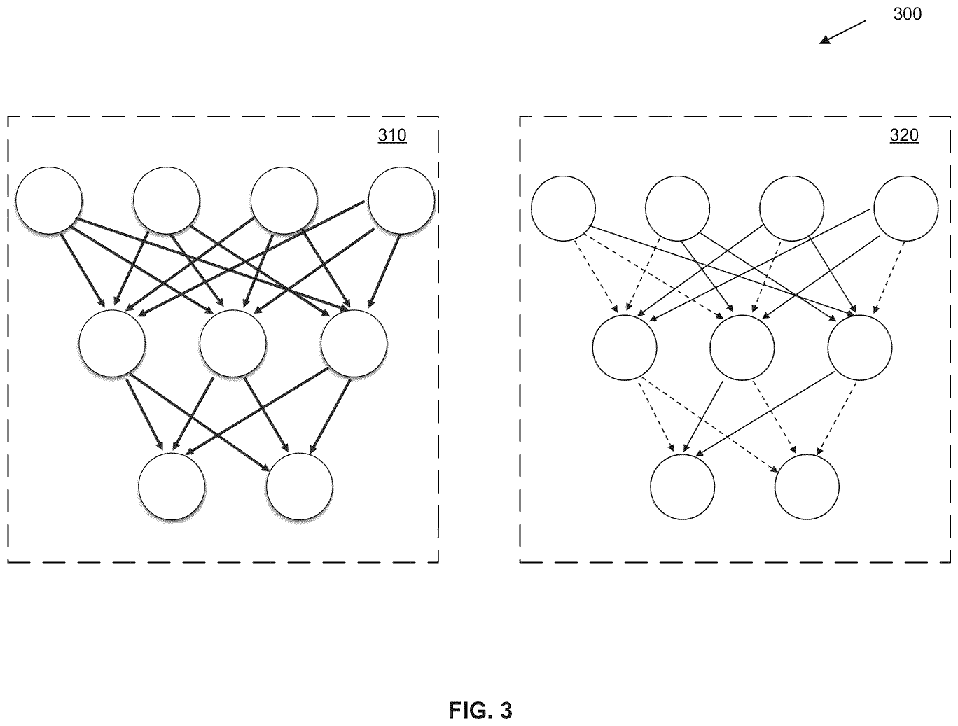

FIG. 3 illustrates a polymorphic pruning method executed by the polymorphic pruning system, in accordance with some of the embodiments disclosed herein. In example 300, pruning system 102 in FIG. 1 may initiate the weight pruning method on a neural network. First set 310 and second set 320 of weights and nodes are illustrated, where the same nodes in a neural network are illustrated in first set 310 and second set 320. A subset of weights are removed (e.g., marked as zeros) in second set 320 of weights and nodes upon executing the weight pruning method described herein. For example, some of the weights in second set 320 may have been deemed as unimportant and removed (e.g., marked as zeros) from the neural network. As shown, the dotted lines in the second set 320 represent the weights that are marked as zeros.

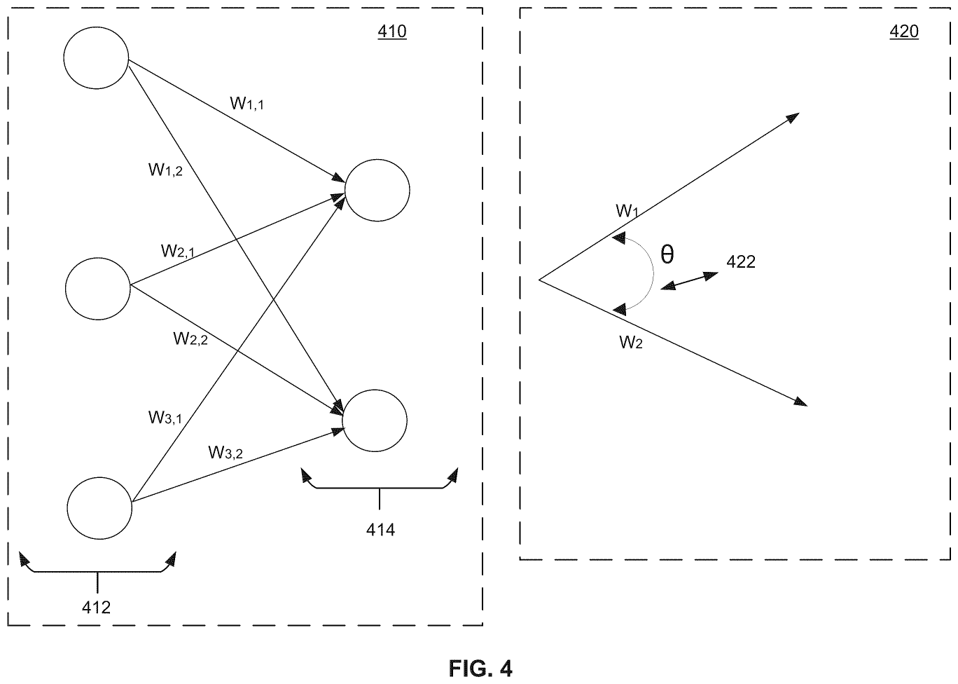

FIG. 4 illustrates a polymorphic pruning method executed by the polymorphic pruning system, in accordance with some of the embodiments disclosed herein. In this example, neural network 410 comprises nodes and weights. Weights (w) are identified and labeled between two layers of the neural network, including first layer 412 and second layer 414. Illustrative weights 420 are provided with angular (0) distance 422. The angular distance 422 is a value between weights in first layer 412 and weights in second layer 414 for the neural network.

During the pruning process, weights that are deemed less significant or redundant are masked to zero, effectively eliminating their contribution to the network's output. In some embodiments, the decision to prune specific weights may be guided by the angular distances between the weights. Weights that exhibit a smaller angular distance are more similar to one another, suggesting they contribute similarly to the network's functionality.

In some embodiments, weights at different layers exhibiting small angular distances may be considered somewhat redundant. As a result, they may be assigned a higher priority for pruning. By removing weights with small angular distances, the pruning process can effectively reduce redundancy while retaining the most diverse and influential connections within the network. This approach ensures that the network continues to perform well, as the remaining weights are more distinct and less likely to overlap in function. Note that angular distance may be just one of many factors considered in the pruning process. Other factors, such as the magnitude of the weights, their contribution to the network's loss function, and their impact on overall network performance, are also taken into account. By integrating angular distance with these other criteria, the pruning method can make more informed decisions, ensuring that the final pruned network is both efficient and robust.

By pruning these similar weights, the network can be streamlined without losing essential diversity in the weight structure. As more weights are pruned, the remaining weights tend to exhibit an increase in angular distance, indicating greater dissimilarity among them. This increased dissimilarity is a desirable outcome of the pruning process, as it suggests that the pruned network retains a diverse set of weights that contribute uniquely to the network's behavior. The goal is to maintain or even enhance the network's ability to generalize and perform well on new data by preserving the most distinct and essential connections.

In the optimization problem discussed above, “i” refers to neurons in first layer 412 and “j” refers to neurons in second layer 414. A basic QUBO model follows the form below:

$$min / max y = {\vec{x}}^{t} Q \vec{x} = {\sum }_{i , j} {Q}_{i , j} {\vec{x}}_{i} {\vec{x}}_{j} \qquad ( 3 )$$

where \vec{x} is a vector of binary decision variables and Q is a matrix of constants. QUBO is an NP-hard problem, and lends itself to finding approximate optimal solutions. QUBO problems contain both linear and quadratic terms, where the linear coefficients appear along the diagonal of matrix Q, while the quadratic coefficients appear as off-diagonal terms.

To provide sufficient disclosure for a person skilled in the art to implement the disclosed weight pruning process, the following description presents the detailed steps in pseudocode, accompanied by explanations.

### Input Parameters:

X: The dataset used to train the model.
M: The neural network model.
N: The number of initial iterations for training, during which the weight information is gathered.

### Initialization:

W←initialize( ): This initializes the weights W of the model. These weights will later be trained and analyzed for pruning.

### Training Process:

The model undergoes N iterations of training. Each iteration involves updating the weights:
   W←train(f(X; W)): The model is trained using the input dataset X and the current set of weights W. The weights W are updated based on the learning process
   M←W: After training step, the neural network model's weights are updated.
   H←W, ΔW, cosW, +params: This step stores weight information into an array H, which includes:
      The current weights W,
      The change in weights ΔW,
      The cosine similarity between weights cosW,
      Other parameters related to the weight change over time.

### Objective Function Creation:

Once the initial training iterations are complete, the system calculates an objective function O based on the collected weight information:

$$O ← {\sum }_{i , j} W {w}_{i} + C {w}_{i} \cdot {w}_{j}$$

This function is designed to optimize the weight pruning process. It balances minimizing correlations between weights while maximizing their individual strength, as described above.

### Optimization Solver (NGQ):

The Next Generation Quantum (NGQ) optimizer (or any other optimization solver) is called to solve the objective function OOO. This solver returns a solution vector V, which is then used to determine which weights to prune.

### Pruning Step:

W←prune(W; V): Using the solution vector V, weights in the network are pruned based on the optimization results. The pruning process modifies the weight matrix W, where certain weights are set to zero (or removed) based on the pruning mask.

### Model Update:

After pruning, the updated weights W are used to modify the model M.
Finally, the pruned weight matrix W and the updated model N are returned.

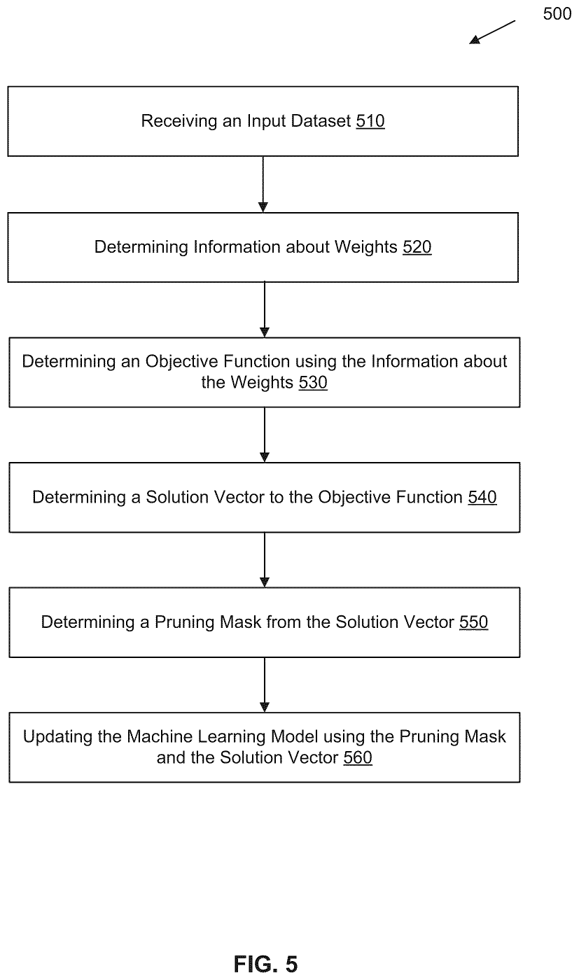

FIG. 5 illustrates a polymorphic pruning method, in accordance with some of the embodiments disclosed herein. For example, pruning system 102 illustrated in FIG. 1 may execute machine readable instructions by processor 104 to perform the functions described herein.

At block 510, an input dataset may be received.

At block 520, information about the weights may be determined.

At block 530, an objective function may be determined using the information about the weights.

At block 540, a solution vector may be determined to the objective function.

At block 550, a pruning mask may be determined from the solution vector.

At block 560, the machine learning model may be updated using the pruning mask and the solution vector.

The process may be implemented by a computer system. The computer system may include a bus or other communication mechanism for communicating information, one or more hardware processors coupled with the bus for processing information. The hardware processor(s) may be, for example, one or more general purpose microprocessors.

The computer system also includes a main memory, such as a random access memory (RAM), cache and/or other dynamic storage devices, coupled to the bus for storing information and instructions to be executed by the processor. The main memory also may be used for storing temporary variables or other intermediate information during execution of instructions to be executed by the processor. Such instructions, when stored in storage media accessible to the processor, render the computer system into a special-purpose machine that is customized to perform the operations specified in the instructions.

The computer system further includes a read only memory (ROM) or other static storage device coupled to the bus for storing static information and instructions for the processor. A storage device, such as a magnetic disk, optical disk, or thumb drive, may be coupled to the bus for storing information and instructions.

The computer system may be coupled via the bus to a display, such as a liquid crystal display (LCD), for displaying information to a computer user. An input device, including alphanumeric and other keys, is coupled to the bus for communicating information and command selections to the processor. Another type of user input device is a mouse, a trackball, or cursor direction keys for communicating direction information and command selections to the processor and for controlling cursor movement on the display. In some embodiments, the same direction information and command selections as cursor control may be implemented via receiving touches on a touch screen without a cursor.

The computing system may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system may implement the techniques described herein using customized hard-wired logic, one or more ASICs or FPGAs, firmware and/or program logic which in combination with the computer system causes or programs the computer system to be a special-purpose machine. According to one embodiment, the techniques herein are performed by the computer system in response to the processor(s) executing one or more sequences of one or more instructions contained in the main memory. Such instructions may be read into the main memory from another storage medium. Execution of the sequences of instructions contained in the main memory causes the processor(s) to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks. Volatile media includes dynamic memory. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise a bus. Transmission media can also take the form of acoustic or light waves, such as those generated during radio-wave and infra-red data communications.

The computer system also includes a communication interface coupled to the bus. The interface provides a two-way data communication coupling to one or more network links that are connected to one or more local networks. For example, the interface may be an integrated services digital network (ISDN) card, cable modem, satellite modem, or a modem to provide a data communication connection to a corresponding type of telephone line. As another example, the interface may be a local area network (LAN) card to provide a data communication connection to a compatible LAN (or WAN component to communicated with a WAN). Wireless links may also be implemented. In any such implementation, the interface sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network links and through an interface, which carry the digital data to and from the computer system, are example forms of transmission media.

The computer system can send messages and receive data, including program code, through the network(s), network links, and interfaces. In the Internet example, a server might transmit a requested code for an application program through the Internet, the ISP, the local network and the interface.

The received code may be executed by the processor as it is received, and/or stored in the storage device, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
receiving an input dataset;
upon providing the input dataset to a training process of a machine learning model, determining information about weights associated with the machine learning model;
determining an objective function using the information about the weights associated with the machine learning model;
determining a solution vector to the objective function;
determining a pruning mask from the solution vector; and
updating the machine learning model using the pruning mask and the solution vector.

2. The method of claim 1, wherein the information about weights associated with the machine learning model is determined during the training process.

3. The method of claim 1, wherein the information about weights includes a strength of each weight (W) and a change in strength between iterations (ΔW).

4. The method of claim 1, wherein the training process of the machine learning model will automatically stop after a predetermined number of iterations while the pruning mask is determined.

5. The method of claim 1, wherein the objective function will maximize a strength of the weights and minimize correlations between the weights.

6. The method of claim 1, wherein pruning is implemented globally on the weights.

7. The method of claim 1, wherein pruning is implemented layer-wise on the weights.

8. A pruning system comprising:
a memory; and
a processor that is configured to execute machine readable instructions stored in the memory for causing the processor to:
receive an input dataset;
upon providing the input dataset to a training process of a machine learning model, determine information about weights associated with the machine learning model;
determine an objective function using the information about the weights associated with the machine learning model;
determine a solution vector to the objective function;
determine a pruning mask from the solution vector; and
update the machine learning model using the pruning mask and the solution vector.

9. The pruning system of claim 8, wherein the information about weights associated with the machine learning model is determined during the training process.

10. The pruning system of claim 8, wherein the information about weights includes a strength of each weight (W) and a change in strength between iterations (ΔW).

11. The pruning system of claim 8, wherein the training process of the machine learning model will automatically stop after a predetermined number of iterations while the pruning mask is determined.

12. The pruning system of claim 8, wherein the objective function will maximize a strength of the weights and minimize correlations between the weights.

13. The pruning system of claim 8, wherein pruning is implemented globally on the weights.

14. The pruning system of claim 8, wherein pruning is implemented layer-wise on the weights.

15. A non-transitory computer-readable storage medium storing a plurality of instructions executable by a processor, the plurality of instructions when executed by the processor cause the processor to perform operations comprising:
receiving an input dataset;
upon providing the input dataset to a training process of a machine learning model, determining information about weights associated with the machine learning model;
determining an objective function using the information about the weights associated with the machine learning model;
determining a solution vector to the objective function;
determining a pruning mask from the solution vector; and
updating the machine learning model using the pruning mask and the solution vector.

16. The non-transitory computer-readable storage medium of claim 15, wherein the information about weights associated with the machine learning model is determined during the training process.

17. The non-transitory computer-readable storage medium of claim 15, wherein the information about weights includes a strength of each weight (W) and a change in strength between iterations (ΔW).

18. The non-transitory computer-readable storage medium of claim 15, wherein the training process of the machine learning model will automatically stop after a predetermined number of iterations while the pruning mask is determined.

19. The non-transitory computer-readable storage medium of claim 15, wherein the objective function will maximize a strength of the weights and minimize correlations between the weights.

20. The non-transitory computer-readable storage medium of claim 15, wherein pruning is implemented globally on the weights or implemented layer-wise on the weights.
